(19) United States
(12) Patent Application Publication
(10) Pub. No.: US 2010/0047750 A1
(43) Pub. Date: Feb. 25, 2010

(54) Educational oral hygiene apparatus

(76) Inventors: Matthew King, San Diego, CA (US); Lloyd Gooch, Hot Springs (AR)

Correspondence Address: MICHAEL E. KLICPERA, PO BOX 573, LA JOLLA, CA, 92038-0573, US

(21) Appl. No.: 12/462,362

(22) Filed: Aug. 3, 2009

Related U.S. Application Data
(63) Continuation-in-part of application No. 11/317,709, filed on Dec. 22, 2005, now abandoned.

(51) Int. Cl. G09B 19/00

(52) U.S. Cl. 434/263

(57) ABSTRACT

A educational oral hygiene apparatus comprising a body having a top and bottom, wherein a first cavity is formed in the body longitudinally extending therein, and an opening formed toward the top of the body, the opening and the first cavity configured to receive a toothbrush; an actuator positioned inside the cavity to engage the toothbrush, when the toothbrush is inserted in the cavity; a storage medium for storing audio information; and a speaker electrically coupled to the actuator and the storage medium, wherein in a first engagement state between the toothbrush and the actuator, the audio information is reproduced in form of audio waves from the speaker. The combination of the figure and the song (with lyrics) teaches and creates a self taught responsibility and interest in accomplishing keeping ones teeth clean by regular bushing.

### RELATED APPLICATIONS

This application is a continuation-in-part of U.S. application Ser. No. 11/317,709 filed Dec. 22, 2005.

### COPYRIGHT & TRADEMARK NOTICE

A portion of the disclosure of this patent document contains material which is subject to copyright protection. The owner has no objection to the facsimile reproduction by any one of the patent document or the patent disclosure, as it appears in the Patent and Trademark Office patent file or records, but otherwise reserves all copyrights whatsoever Certain marks referenced herein may be common law or registered trademarks of third parties affiliated or unaffiliated with the applicant or the assignee. Use of these marks is by way of example and shall not be construed as descriptive or limit the scope of this invention to material associated only with such marks.

### FIELD OF THE INVENTION

The present invention relates in general to a educational oral hygiene apparatus, and more particularly to a musical educational oral hygiene apparatus that plays a musical tune or song when the toothbrush is removed from the educational oral hygiene apparatus.

### BACKGROUND

Many children and adults dislike brushing or flossing their teeth. Some just lack the patience, discipline or energy to brush before going to bed, school or work. Typically, the ones who do only spend a minimum amount of time on these important daily hygiene exercises.

Unfortunately, most toothbrushes and other oral hygiene instruments presently in the market do not provide a fun and engaging environment that would provide some means of motivation to effectively complete brushing. A system and method is needed to overcome this problem. There is also a need to provide a timed environment to guide the users to spend sufficient time brushing or flossing their teeth.

### SUMMARY OF THE INVENTION

Features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

In accordance with one or more embodiments, a educational oral hygiene apparatus comprises a body having a top and bottom, wherein a first cavity is formed in the body longitudinally extending therein. An opening formed toward the top of the body, the opening and the first cavity configured to receive a toothbrush. The first cavity configured to receive a toothbrush can be removed to provide a second cavity which can receive larger sized electric toothbrushes. Hence the present invention includes a universal toothbrush holder.

In a first engagement, an actuator positioned inside the cavity engages or senses the toothbrush, when the toothbrush is inserted in the cavity. A storage medium may be included for storing audio information and a speaker electrically coupled to the actuator and the storage medium.

In a second engagement state the audio information is reproduced in form of audio waves from the speaker whereby the reproduction of the audio information is discontinued at the end of educational musical song.

The first engagement state comprises the toothbrush engaging or sensing the actuator. The second engagement state comprises the toothbrush disengaging the actuator or a light beam received by a sensor. The first engagement state occurs when the toothbrush is inserted in the cavity. The second engagement state occurs when the toothbrush is removed from the cavity.

In exemplary embodiment, the storage medium is flash memory incorporated within a microprocessor for the reproduction of the audio information.

In another embodiment, a processor may be also included for controlling duration of reproduction of the audio waves.

In accordance with another aspect of the invention, a base for receiving an oral care instrument comprises a body having a top and bottom, wherein a first cavity is formed in the body and an opening is formed toward the top of the body, the opening and the first cavity configured to receive the oral care instrument; an actuator positioned inside the cavity to engage the oral care instrument, when the oral care instrument is inserted in the cavity.

Some embodiments comprise a storage medium for storing audio information; and a speaker electrically coupled to the actuator and the storage medium, wherein in the second engagement state between the educational oral care instrument and the actuator, the audio information is produced in form of audio waves from the speaker.

It is one object of the present invention to provide an educational oral hygiene apparatus which teaches, coaches and/or promotes primarily children to brush their teeth.

It is also an object of the present invention to provide an educational oral hygiene apparatus which employs a copyrighted song or melody.

It is also an object of the present invention to provide a means for the drainage of tooth brushing solutions, residue and debris from the present invention in actual use to maintain the functionality and cleanliness of the apparatus.

It is also an object of the present invention to provide components that are subjected to tooth brushing solutions, residues and debris which can be removed, cleaned appropriately, and replaced for use.

These and other embodiments of the present invention will also become readily apparent to those skilled in the art from the following detailed description of the embodiments having reference to the attached figures, the invention not being limited to any particular embodiments disclosed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1A illustrates an exemplary educational oral hygiene apparatus according to one embodiment of the invention.

FIG. 1B illustrates the educational oral hygiene apparatus according to another exemplary embodiment.

FIG. 2 illustrates an exemplary electrical circuit according to another embodiment of the invention for the educational oral hygiene apparatus of FIG. 1 or 2.

FIG. 3 illustrates yet another exemplary embodiment for the educational oral hygiene apparatus of the invention in the shape of a 700 figurine.

FIG. 4 illustrates is a refined exemplary embodiment for the educational oral hygiene apparatus of the present invention in the shape of a figurine.

FIG. 5 illustrates an exploded sectional view of the exemplary embodiment showing four components; a removable tooth brush container, displayed tooth illustration piece, circuit board, and the rear power source container.

FIG. 6 is a front view of the displayed tooth illustration piece with the base structure.

FIG. 7 is a side sectional view of the educational educational oral hygiene apparatus taken from FIG. 6 and showing the location of various electronic components, the power source container, the tooth brush removable container and the base structure

FIG. 8 is a top partial side view of the base structure showing the water drain channels and holes and protected screw enclosures.

FIG. 9 is a representative electronic schematic of the exemplary other embodiment of the present invention.

Features, elements, and aspects of the invention that are referenced by the same numerals in different figures represent the same, equivalent, or similar features, elements, or aspects in accordance with one or more embodiments of the system.

### DETAILED DESCRIPTION OF THE PREFERRED EMBODIMENTS

In the following, reference is made to the accompanying drawings that illustrate various embodiments of the invention. It is to be understood that other embodiments may be utilized and structural changes may be made without departing from the scope of the present invention.

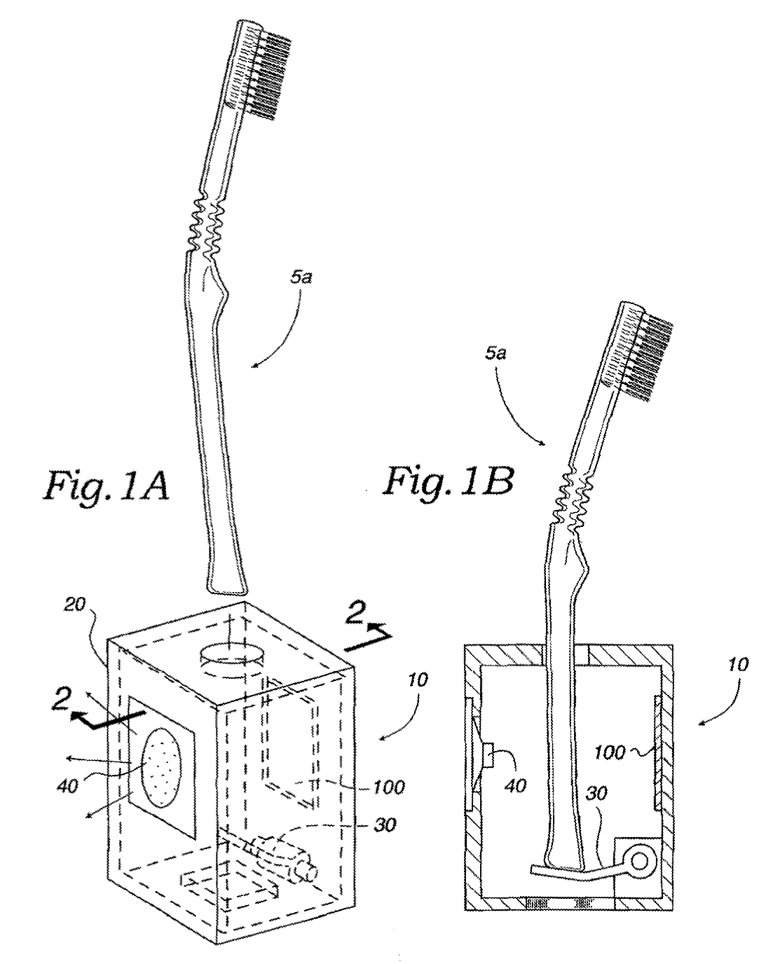

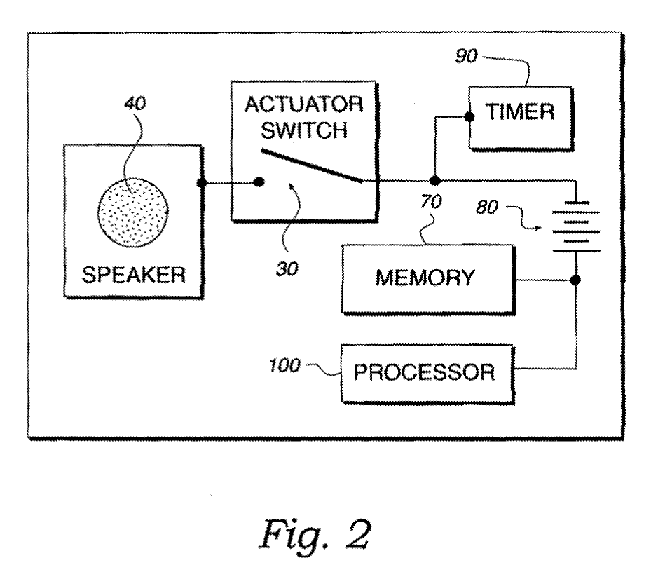

Referring to FIGS. 1 and 2, to achieve these and other advantages and in accordance with the purpose of the present invention, as embodied and broadly described, a educational oral hygiene apparatus 10 comprises a body 20 having an opening on the top and a cavity extending therefrom longitudinally within the body 20 to respectively receive and house a toothbrush 50, for example.

The holder 10 may be a housing canister, base, container, cradle or any other structure on or in which a toothbrush or some oral hygiene instrument can rest. The toothbrush 50 can be any type of toothbrush. In the following, one or more aspects of the invention are by way of example described with reference to a regular toothbrush 50 comprises of a handle and bristles. It is noteworthy, however, that this invention in other embodiments may be applicable to any type of toothbrush, or other oral care or hygiene instruments.

As illustrated in FIG. 1, the holder 10 in a preferred embodiment comprises an actuator 30 disposed within the cavity, such that when the toothbrush 50 is inserted in the cavity, the actuator 30 engages an end of toothbrush 50. In certain embodiments the opening and the cavity are designed to receive the handle of toothbrush 50. In other embodiments, the cavity and the opening are designed to receive the head of toothbrush 50.

In alternative embodiments, body 20 may be designed without a cavity or opening, such that actuator 30 is disposed on a surface level. For example, actuator 30 may be designed in the shape of a cradle for receiving the handle of toothbrush 50. In such exemplary embodiment, actuator 30 is in a first engagement status (e.g., “on” status) when the weight of toothbrush 50 bears down on actuator 30 and in a second engagement status (e.g., “off” status) when no pressure is applied to actuator 30.

Referring back to FIG. 1, in a preferred embodiment, actuator 30 is a pressure activated lever positioned inside the cavity such that when toothbrush 50 is inserted through the opening into the cavity, one end of toothbrush 50 engages actuator 30 to place actuator 30 in a first engagement position (e.g., “on” position).

In primary embodiment, infrared or LED lights beams or other suitable on/off optical switching means are utilized. In another embodiments, actuator 30 may be situated at the bottom of the cavity or other portions of the cavity. Actuator 30 may be activated by way of a pressure control mechanism. Accordingly, actuator 30 functions to detect or sense the engagement of toothbrush 50 with educational oral hygiene apparatus 10 and also detect or sense when the toothbrush 50 is removed.

It is also contemplated by the Applicant, that actuator 30 can be a lever with a biasing property, so that when toothbrush 50 is removed from the cavity, actuator 30 is returned to a second engagement position as a result of the biasing property acting against the weight of toothbrush 50. The biasing property may be implemented in actuator 30 by way of a spring-loaded lever, for example, or other suitable mechanical biasing member.

In one or more embodiments, educational oral hygiene apparatus 10 comprises a speaker 40 controlled by actuator 30 by way of wired or wireless signals. When actuator 30 is in the second engagement position (i.e., “on” position) then an audio signal is produced from speaker 40. The audio signal may be a melody or other alert tone. In a preferred embodiment, the audio signal is an educational song or tune that is played for a predetermined period of time or alternately until toothbrush 50 is placed back in educational oral hygiene apparatus 10.

Referring to FIG. 2, in accordance with one aspect of the invention, actuator 30 acts as a switch in an electrical circuit comprising at least one of speaker 40, a storage medium or memory 70, a power source 80 and a processor 100. Storage medium or memory 70 may comprise any audio data recording medium such as flash memory, Read Only Memory (ROM), electrically erasable programmable read-only memory (EEPROM), Random Access Memory (RAM), a disk drive or CD, depending on implementation.

In an exemplary embodiment, storage medium 70 may be removable so that a user may burn or record the user's favorite music or song on storage medium 70. In other embodiments, storage medium 70 may be fixed within body 20 and as provided by the manufacturer. In alternative embodiments, storage medium 70 can be electrically or wirelessly manipulated for data recording thereon, without removal.

Power source 80 may be a battery or other electrical source such as an electrical outlet, for example. Power source 80 feeds a current to the exemplary electrical circuit illustrated in FIG. 2 to support the operation of actuator 30 and speaker 40 as noted above.

In one embodiment, a timer 90 may be coupled to the electrical circuit to limit the reproduction of audio signal stored on storage medium 70 to a predetermined period. For le, timer 90 may be set by a user to a time which the user wishes to brush his teeth. Accordingly, the user is encouraged to continue to brush his or her teeth while the audio or the music recorded on storage medium 70 is played.

A preferred embodiment of the invention may be designed for educating, teaching, and/or coaching children to encourage them to brush their teeth for a predetermined time. As such, musical tunes or songs that appeal to children may be stored and played. In one embodiment, the tune is played for at least two minutes, or other recommended length of time considered appropriate for brushing all four teeth quadrants. In some embodiments, an alert signal is produced preferable at 30-second intervals, for example, to alert a user to brush another quadrant. Instead of the alert signal, a different tune may be played every 30 seconds, in another embodiment.

It is note worthy that the two-minute or the 30-second intervals noted above are provided by way of example. In different embodiments, alternate time periods may be used. For example, in accordance with yet another embodiment, a processor 100 may be coupled to the electrical circuit illustrated in FIG. 2. Processor 100 may be configured to control the duration, type, volume, genre, or other attribute of audio information recorded and reproduced.

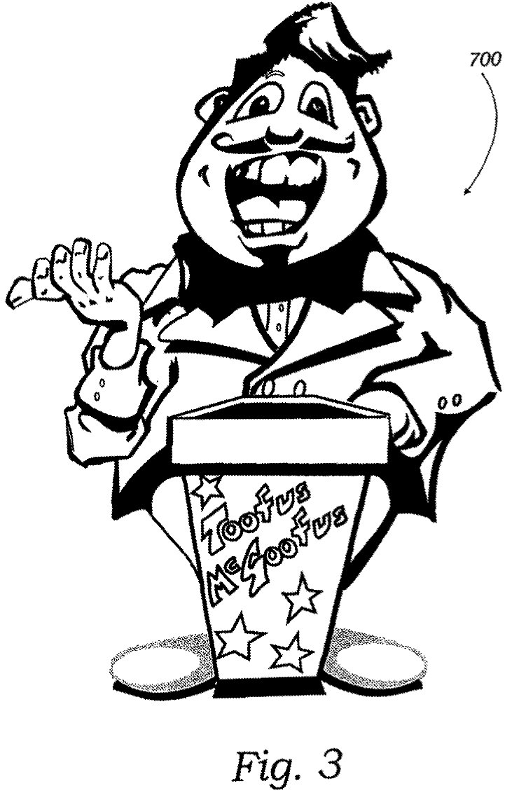

As such, a user may be provided with a variety of tunes that can be refreshing, motivational and fun. For example, in one embodiment the tune may be an opera piece with educational lyrics encouraging the user to brush his or her teeth. Referring to FIG. 3, in one exemplary embodment, the displayed components in FIG. 1 or 2 may be embodied into a 700a figurine. As shown, the 700a figurine may be in the shape of an opera singer, for example.

In other embodiments, the 700a figurine may be in the shape of an animated character, such as Bugs Bunny, or any other character (e.g., ballerina, toy soldier, etc.), instrument (e.g., piano, harp, etc.) or device (e.g., racecar, airplane, etc.) that may be amusing to a user. Parts of the 700a figurine, in certain embodiments, may move for entertainment purposes while the tune is played.

The invention has been described with reference to one or more embodiments. It is evident that other alternatives, modifications, variations and embodiments may be apparent to those skilled in the art in light of the foregoing description.

For example, while processors, controllers and other circuits, are described in terms of specific logical/functional circuitry relationships, one skilled in the art will appreciate that such may be implemented in a variety of ways, such as appropriately configured and programmed processors, ASICs (application specific integrated circuits), and DSPs (digital signal processors).

Show in FIG. 3 is another exemplary embodiment for the educational oral hygiene apparatus of the invention in the shape of a 700a figurine.

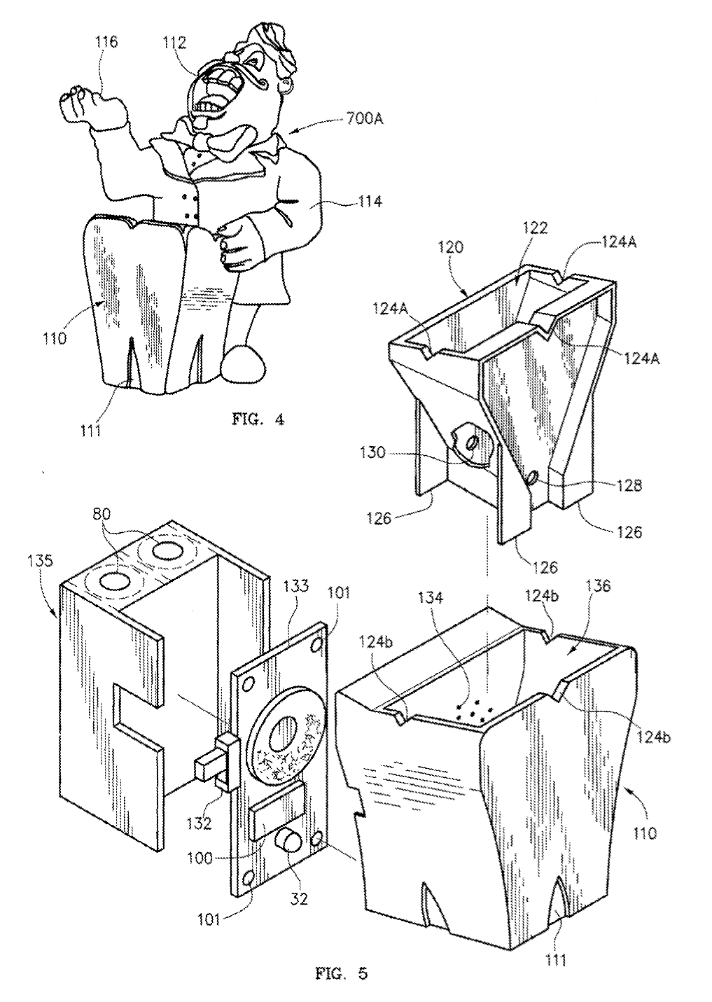

Shown is FIG. 4 illustrates is a refined exemplary embodiment for the educational oral hygiene apparatus of the present invention in the shape of a figurine 700b. Figurine 700b includes a character that has it mouth wide open and showing his clean white teeth 112. The FIG. 700b also includes a simulated tooth 110 with one or more indentations 111. The Figurine 700b has one arm 116 facing in an upward direction and the other arm 114 in a side posture position and resting on the simulated tooth 110. As an example, the FIG. 700b is in a configuration that represents a singing figure that clearly shows his teeth 112 and a simulated front tooth piece 110. The combination of the FIG. 700b and the song (with lyrics) teaches and creates a self taught responsibility and interest in accomplishing keeping ones teeth clean by regular bushing. Typical materials for fabricating the figurine 700b include, but are not limited to, thermoplastics or thermoset plastics such as polyvinyl chloride (PVC), Acrylonitrile butadiene styrene (ABS), polyurethane, latex, acrylic and curable compositions, such as epoxy, polysulfides, polythioethers, polyethers and polyisocyanates, Nylon, Dacron, synthetic polyamide, polyetheretherketone (PEEK), expanded polytetrafluroethylene (e-PTFE), polyethylene and ultra-high molecular polyethylene (UHMWPE) commercially available as Spectra™ or Dyneema™, as well as other high tensile strength materials such as Vectran™, Kevlar™. Alternatively the present invention figurine 700b may be formed from metallic materials, for example, stainless steel, elgiloy, Nitinol, or other metals. The figurine 700b can also be partially or completely painted or imprinted with any particular design to mimic various designs.

Now referring to FIG. 5, the present invention includes four components shown in an exploded sectional view. The four components of this exemplary embodiment comprise a removable tooth brush container 120, simulated front tooth piece 110, a circuit board 133, and the rear power source container 135. The removable tooth brush container 120 has a cavity 122 for enclosing one or more tooth brushes and includes a rear hole 130 and a front hole 128 which allows the light beam from the LED to be received by the sensor (when the tooth brush is removed from the removable container 120). The removable tooth brush container 120 also has one of more (three shown) indentations 124 a, b, c to support the representation of a tooth. The removable tooth brush container 120 is designed to be inserted within and become substantially removably engaged to the simulated tooth front piece 110. The removable tooth brush container 120 has a series of wing shaped legs 136 that provide stability when inserted into the simulated tooth front piece 110. The series of wing shaped legs 136 also functions to arrange the front hole 128 and rear hole 130 for proper alignment with the actuator LED light beam. The removable container 120 is preferably fabricated from a polymeric or metallic material that allows quick and effective washing without discoloration or degradation. The removable container 120 is preferably fabricated from a polymeric or metallic material that can be cleaned in a typical dishwasher. Periodic cleaning of the removable tooth brush container 120 is essential for proper functionality as residue and debris from used tooth brushes placed in the container 120 (e.g. front hole 128 or rear hold 132 can become occluded). In addition, proper cleaning of the removable tooth brush container 120 minimizes the clinical possibility of bacterial and viral contamination. Not shown are a series of holes and channels in the removable tooth brush container 120 that allow for drainage and removal of tooth brush residue and debris as discussed in more detail below. It is a design feature of the present invention to maintain the apparatus in a clean state that is free of solutions and debris in an effort to also teach children to keep their teeth clean.

Simulated front tooth piece 110 includes a cavity 137 that is designed to receive the removable tooth brush container 120. The simulated front tooth piece 110 includes a series of indentures near the base 111 and a series near the top 124b which align with the indentures 124a of the removable tooth brush container 120. On the rear section of the simulated tooth piece 110 are a plurality of speaker holes for allowing the dissemination of sound waves from the speaker 40.

The circuit board 133 includes a microprocessor 100, an LED light source 32, a power switch 132, and a plurality of holes 131 for mounting between the simulated tooth piece 110 and the rear power source container 135. Not shown in FIG. 5 (but shown in FIG. 7) is the sensor that is designed to sense the light beam from the LED source 32.

The rear power source container 135 includes a structure for containing the power source 80 (batteries) and a cut out 139 for the switch 132.

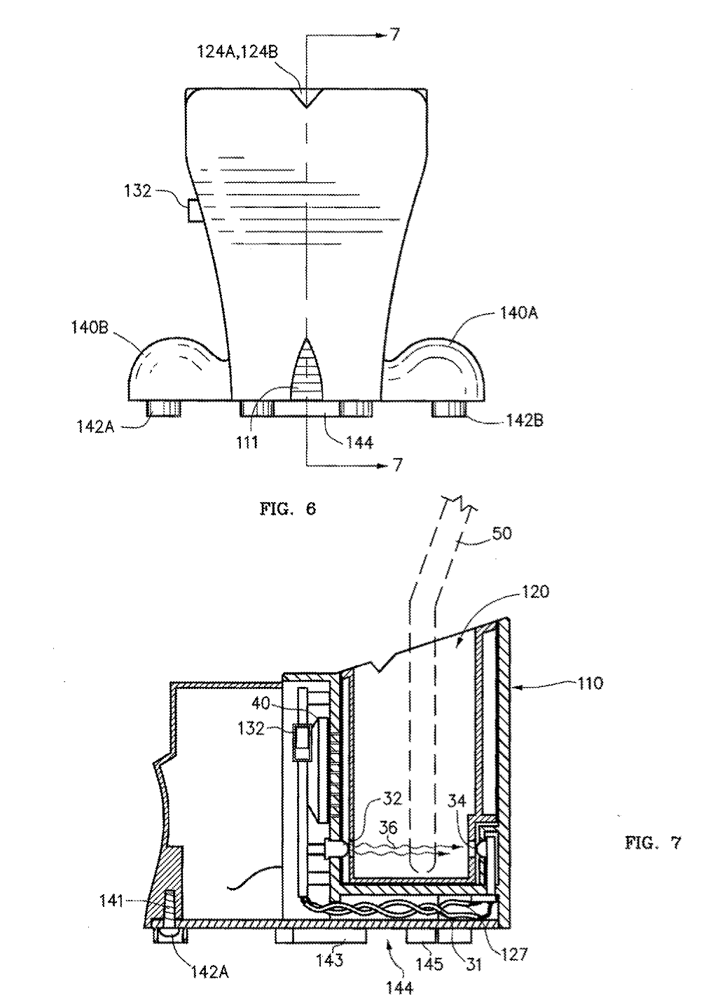

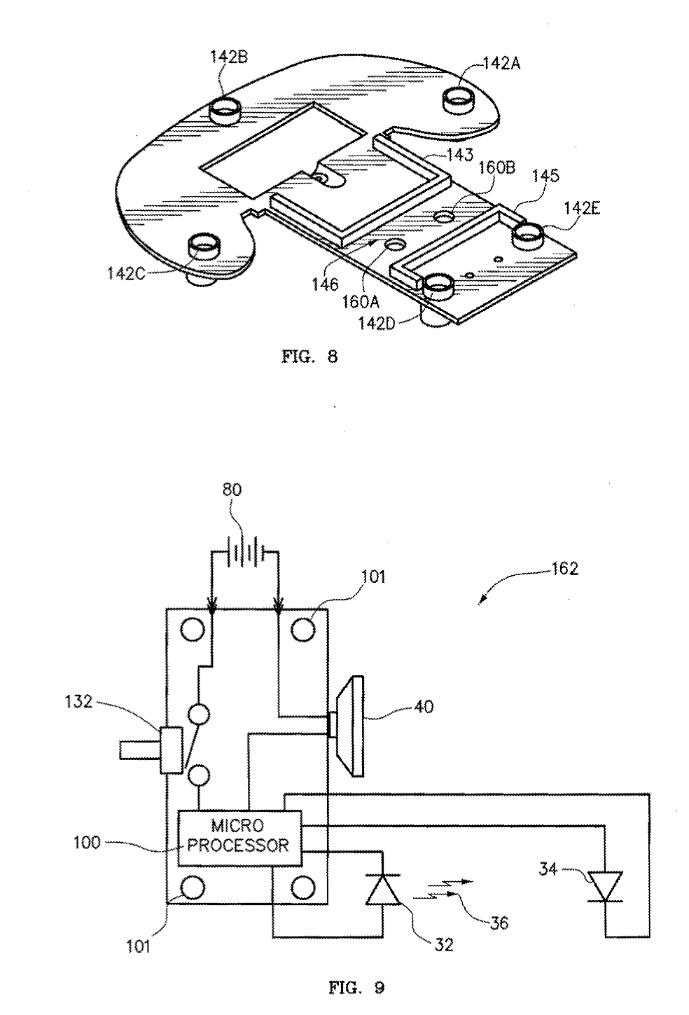

Now referring to FIG. 6, a front view of the simulated front tooth piece 110 with the base structure is shown. As described in FIG. 5, the simulated front tooth piece 110 includes a series of indentures near the base 111 and a series near the top 124b which align with the indentures 124a. Important aspect of the design of the present invention is the draining of tooth brushing residue and debris through the drainage area 144. As shown in FIG. 6, the simulated front tooth piece 110 has at least two feet (shown as 140a and 140b in FIG. 6) which provide stability to the Figurine 700b. Extending downward from feet 140a and 140b are lifters 142a and 142b, respectively. The lifters 142a and 142b incorporate mounting screws which are protected from water and tooth brush/paste residue and debris, thereby minimizing degradation or corrosion of the screws. The lifters 142 a, b, c, d, and e on the bottom create channels 146 for directing residue, solutions and debris away from the metallic screws.

Shown in FIG. 7. is a side sectional view of the educational oral hygiene apparatus taken from FIG. 6 and showing the location of various electronic components, the power source container, the tooth brush removable container and the drainage base structure. The electronic components in FIG. 7 basically comprise the on/off switch 132, the speaker 40, the LED light source 32, associated wiring 31 and the light sensor 34 which are in electronic communication. A toothbrush 50 is shown inserted in the removable tooth brush cavity 120 and breaking the transmission of the light beam 36 from LED light source 32 from communicating with sensor 34. When the tooth brush is removed from the removable tooth brush cavity 120 the light beam is sensed by the sensor 34 thereby completing the electrical circuit and initiating the educational tooth brushing musical melody. As described previously, the removable tooth brush container 120 is designed to be inserted within and become substantially removably engaged to the simulated tooth front piece 110. When the removable tooth brush container 120 is removed the second cavity can serve to contain a larger electric tooth brush and maintain all of the LED sensing and draining features described. Therefore, the present invention has a universal tooth brush design. Focusing on the bottom structure, the drainage area 144 is separated by a front wall 145 and a back wall 143. Drainage area 144 is in liquid communication with the draining holes in the removable tooth brush container 120 and the simulated tooth front piece 110. Shown in more detail is lifter 142 a designed to protect mounting screw 141a from becoming contaminated or corroded from the toothbrush solutions, residues and debris.

As shown in FIG. 8, a bottom partial side view of the base structure shows the drain channel 144 and holes, 160 and 161 and protected screw enclosures or risen circular edges (lifters), 142 a, b, c, d, and e. The drain channel 144 is shown with one drain hole on the right side 160a and one drain hole on the left side 160b. It is anticipated by the Applicants that one or more drains holes can be used with the present invention. The drain channel 144 includes a front wall structure 145 and a rear wall structure 143, and the drain holes 160 a, b. to direct the to channel solutions, residue and debris away from the apparatus. The lifters or risen circular edges 141a, b, c, d, and e, are added to further protect the screws from solution, residue and debris.

FIG. 9 is a representative electronic schematic of the exemplary other embodiment of the present invention. Shown in the representative electronic schematic are a power source (battery) 80, on/off switch 132, microprocessor with flash memory 100, a speaker 40, a light emitting diode (LED) 32, and a light emitting sensor 34. Shown emanating from the LED is a light beam 36. The microprocessor can include a flash memory module that stores and plays the digital educational song or melody and any timing elements necessary to terminate operations, e.g. reduce power levels after the song has been played. An example of a microprocessor that can be used with the present invention is the General Plus Microprocessor Model GPC-111512c-169A fabricated by General Plus Technology, Inc. located in Taiwan

Accordingly, it should be understood that the invention is not limited by the foregoing descriptions of the preferred embodiments but embraces all alternatives, modifications, and variations in accordance with the spirit and scope of the appended claims and their full scope of equivalents.

1. A educational oral hygiene apparatus comprising:
a body having a top and bottom, wherein a cavity is formed in the body longitudinally extending therein, and an opening formed toward the top of the body, the opening and the first cavity said body having a three dimensional human-like figurine having exposed teeth;
said cavity removable engaged to a substantially universal toothbrush compartment configured to receive either a non-electric or an electric toothbrush, said compartment having one or more holes in a bottom surface wherein said holes function to allow solutions and residue associated with toothbrush use to drain from said compartment, said compartment being removable from said cavity for cleansing, said compartment being dishwasher safe;
a microprocessor, said microprocessor designed to control the duration of reproduction of the audio waves in the first engagement state, said microprocessor electrically coupled to an optical sensing means, and a speaker;
said optical sensing means positioned inside the compartment and cavity, said optical sensing means is electrically coupled to said microprocessor, said optical sensing means functioning to provide information when a toothbrush is removed from said compartment to said microprocessor;
a storage medium for storing audio information;
a speaker electrically coupled to said microprocessor;
wherein the first engagement state comprises the toothbrush is sensed by optical sensing means to be contained within the cavity;
wherein in the second engagement occurs when said toothbrush is removed from the cavity and reproduction is the audio information is performed.

2. The educational oral hygiene apparatus of claim 1, wherein the storage medium is flash memory.

3. The education oral hygiene apparatus of claim 1, further comprising said reproduction of audio continues until the said reproduction is completed.

4. The educational oral hygiene apparatus of claim 1, further comprising a timer for extending reproduction of the audio information to a predetermined period in the second engagement state.

5. The educational oral hygiene apparatus of claim 1 wherein said audio information is a song that is an educational tooth brushing musical melody.

6. The educational oral hygiene apparatus of claim 1 wherein said audio information is a song that is copyrighted.

7. The educational oral hygiene apparatus of claim 1 wherein said audio information is a song includes lyrics that teaches and creates a self taught responsibility and interest in accomplishing keeping ones teeth clean by regular bushing.

8. The base for receiving an oral care instrument of claim 4, further comprising said reproduction of said audio information has its volume reduced in stages over a pre-determined period.

9. A base for receiving an oral care instrument, the base comprising:
a body having a top and bottom, wherein a first cavity is formed in the body longitudinally extending therein, and an opening formed toward the top of the body, the opening and the first cavity, said body having a three dimensional human-like figurine having exposed teeth;
said cavity removable engaged to a substantially universal toothbrush compartment configured to receive either a non-electric or an electric toothbrush, said compartment having one or more holes in a bottom surface wherein said holes function to allow solutions and residue associated with toothbrush use to drain from said compartment, said compartment being removable from said cavity for cleansing, said compartment being dishwasher safe;
a microprocessor, said microprocessor designed to control the duration of reproduction of the audio waves said microprocessor electrically coupled to an actuator, and a speaker;
an optical sensing means positioned inside the compartment and cavity, said optical sensing means is electrically coupled to said microprocessor, said optical sensing means functioning to provide information when a toothbrush is removed from said compartment to said microprocessor;
a storage medium for storing audio information;
a speaker electrically coupled to said microprocessor;
wherein reproduced in form of audio waves emitted from the speaker continues until the reproduction of audio information is terminated.

10. The base for receiving an oral care instrument of claim 9 wherein the storage medium is flash memory.

11. The base for receiving an oral care instrument of claim 9, further comprising said reproduction of audio continues until the said reproduction is completed.

12. The base for receiving an oral care instrument of claim 9, further comprising a timer for extending reproduction of the audio information to a predetermined period in the second engagement state.

13. The base for receiving an oral care instrument of claim 9 wherein said audio information is a song that is an educational tooth brushing musical melody.

14. The base for receiving an oral care instrument of claim 9 wherein said audio information is a song that is copyrighted.

15. The base for receiving an oral care instrument of claim 9 wherein said audio information is a song includes lyrics that teaches and creates a self taught responsibility and interest in accomplishing keeping ones teeth clean by regular bushing.

16. The base for receiving an oral care instrument of claim 12, further comprising said reproduction of said audio information has its volume reduced in stages over a pre-determined period.
